(19) United States
(12) Patent Application Publication
(10) Pub. No.: US 2019/0185150 A1
(43) Pub. Date: Jun. 20, 2019

(54) SPLIT YOKE IN A FOLDING ROTOR BLADE ASSEMBLY

(71) Applicant: Bell Helicopter Textron Inc., Fort Worth, TX (US)

(72) Inventors: Jared Mark Paulson, Fort Worth, TX (US); Tyler Wayne Baldwin, Keller, TX (US); Kyle Thomas Cravener, Watauga, TX (US)

(73) Assignee: Bell Helicopter Textron Inc., Fort Worth, TX (US)

(21) Appl. No.: 15/845,720

(22) Filed: Dec. 18, 2017

(51) Int. Cl. B64C 27/50; B64C 3/56; B64C 29/00

(52) U.S. Cl. CPC B64C 27/50; B64C 29/0033; B64C 3/56

(57) ABSTRACT

A yoke split into separate, individual yoke arms permit rotor blade fold about inboard yoke arm bolts in a rotor blade assembly for rotorcraft and tiltrotor aircraft. In use, the compact folded arrangement of the rotor blades reduces folded aircraft dimensions in response to ever increasing restricted storage space parameters.

### CROSS-REFERENCE To RELATED APPLICATIONS

This patent application is related to U.S. Patent Application entitled “Compact Folding Yoke In A Folding Rotor Blade Assembly,” Docket No. 60388-P007US; U.S. Patent Application entitled “Compact Folding Yoke With Flexible Yoke Arms In A Folding Rotor Blade Assembly,” Docket No. 60388-P008US; U.S. Patent Application entitled “Dual Blade Fold Bolts And Inboard Centrifugal Bearing In A Folding Rotor Blade Assembly,” Docket No. 60388-P009US; and U.S. Patent Application entitled “Folding Spindle And Bearing Assembly In A Folding Rotor Blade Assembly,” Docket No. 60388-P010US; and U.S. Patent Application entitled “Outboard Centrifugal Force Bearing With Inboard Blade Fold Axis In A Folding Rotor Blade Assembly,” Docket No. 60388-P011US. Each patent application identified above is filed on the same date as this patent application and is incorporated herein by reference in its entirety.

### BACKGROUND

This section provides background information to facilitate a better understanding of the various aspects of the disclosure. It should be understood that the statements in this section of this document are to be read in this light, and not as admissions of prior art.

Rotorcraft and tiltrotor aircraft are often transported or stored on vessels or in areas where storage space is limited. In order to reduce the space that each aircraft occupies such that the maximum number of aircraft can be accommodated within the limited storage space, the blade assemblies of some rotor systems can be folded so that each rotor blade is generally parallel with each other in order to reduce the overall profile of the blade assembly. Typically, each rotor blade is folded about a single pivot point positioned outboard of the yoke that attaches the rotor blade to the central drive mast. The single pivot point is also necessarily outboard of an essential set of inboard and outboard bearings that connect the rotor blade to the yoke. The distance between the inboard and outboard bearings is dependent on aircraft configuration where each configuration has an optimal distance for that particular aircraft's loads and dynamics. As a result, the pivot point of each rotor blade is typically at least that optimal distance out from the rotor blade's inboard connection to the yoke.

In an effort to transport or store larger numbers of rotorcraft and tiltrotor aircraft, current naval vessels have reduced the allotted storage space available for each aircraft. Present rotor blade folding systems cannot accommodate the reduced space parameters. This requirement necessitates a tighter grouping of the rotor blades than is currently available by prior art rotor blade folding systems.

### SUMMARY

An example of a split yoke for a folding rotor blade assembly includes a bilateral hub spring including an upper hub spaced from a lower hub, a yoke arm connected to the bilateral hub spring between the upper hub and the lower hub, a first connection point of the yoke arm to the bilateral hub spring including a removable bolt, and a second connection point of the yoke arm to the bilateral hub spring, wherein the yoke arm pivots relative to the bilateral hub spring about the second connection point when the removable bolt is removed from the first connection point.

An example of a system for folding a rotor blade assembly includes a hub spring operatively connected to a central mast, a yoke arm connected to the hub spring at a releasable point and a pivot point, and a plurality of bearings connecting the yoke arm to a rotor blade, the plurality of bearings positioned on the yoke arm outboard of the pivot point.

An example of a method for folding a rotor blade assembly comprising a yoke arm connected to a hub spring with a releasable connection and a pivotable connection includes pitching a rotor blade connected to the yoke arm, releasing the releasable connection of the yoke arm, and pivoting the yoke arm about the pivotable connection.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1A is a perspective view of a tiltrotor aircraft in a flight ready position according to aspects of the disclosure.

FIG. 1B is a perspective view of a tiltrotor aircraft in a stowed position according to aspects of the disclosure.

FIG. 2A is a partial perspective view of a blade assembly in an unfolded position according to one or more aspects of the disclosure.

FIG. 2B is a partial side view of a blade assembly in an unfolded position according to one or more aspects of the disclosure.

FIG. 3 is a partial top view of a rotor blade and yoke arm according to aspects of the disclosure.

FIG. 4 is a top view of a rotor blade assembly in a folded position according to aspects of the disclosure.

FIG. 5 is a flowchart of the actions performed in converting a tiltrotor aircraft from a flight ready position to a stowed position according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

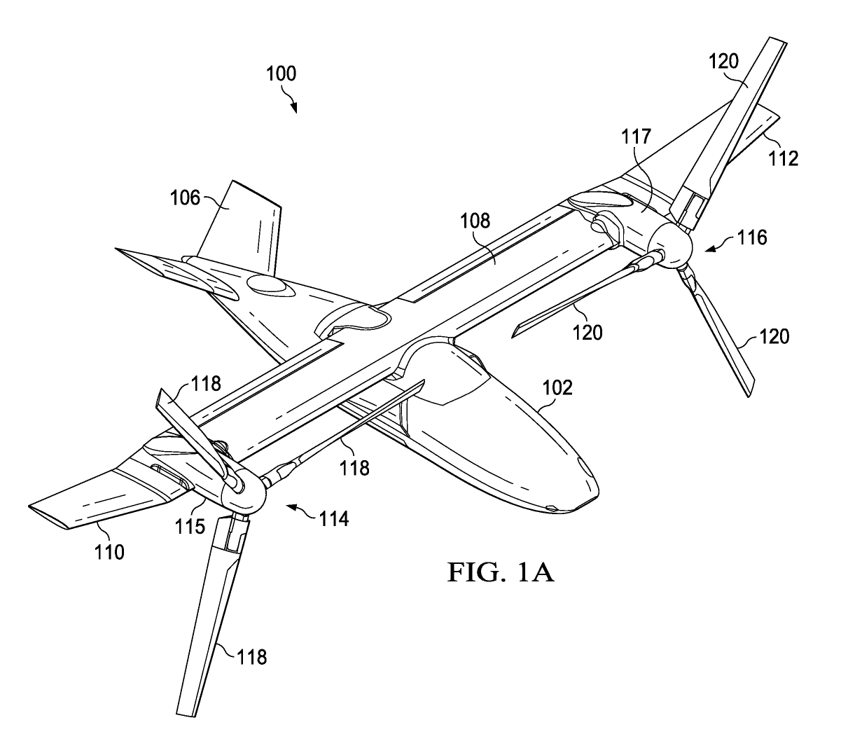

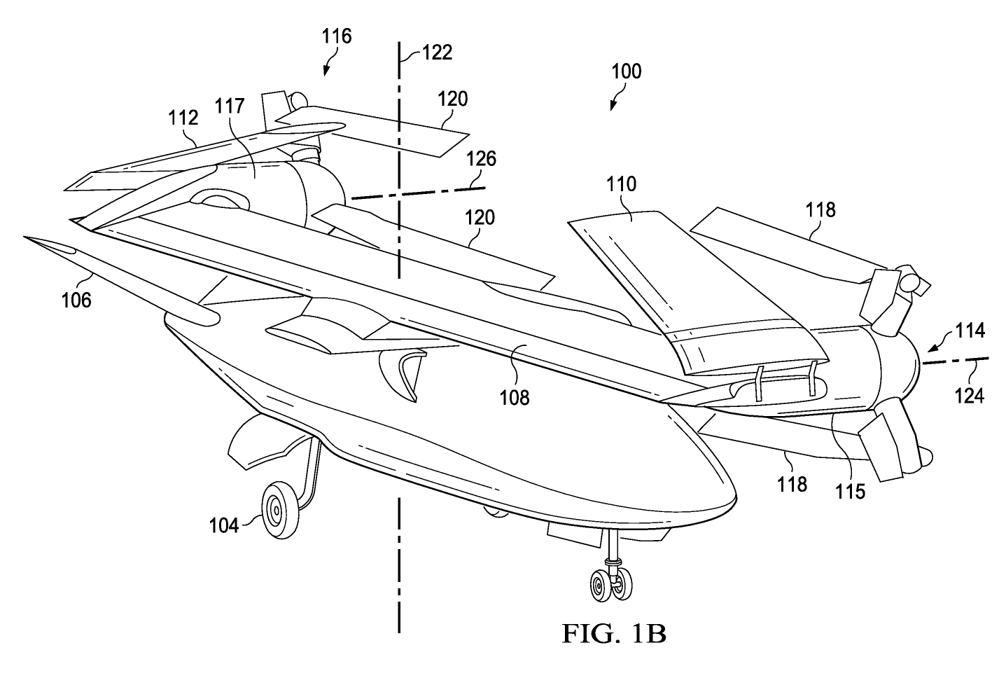

Referring to FIGS. 1A and 1B, an illustrative tiltrotor aircraft 100 is shown. Tiltrotor aircraft 100 includes fuselage 102, landing gear 104, tail member 106, wing 108, wing tip 110, wing tip 112, rotor system 114, and rotor system 116. Rotor system 114 is housed within nacelle 115 located on an end portion of wing 108 proximate wing tip 110, while rotor system 116 is housed within nacelle 117 located on an opposite end portion of wing 108 proximate wing tip 112. Wing tip 110 is pivotable at a location on wing 108 outboard of nacelle 115. Wing tip 112 is pivotable at a location on wing 108 outboard of nacelle 117. Nacelles 115 and 117 are pivotable between a helicopter mode where the rotor systems are generally vertical and an airplane mode where the rotor systems are generally horizontal. Nacelle 115 and nacelle 117 are substantially symmetric of each other about fuselage 102. Rotor system 114 includes a plurality of foldable rotor blades 118. Rotor system 116 includes a plurality of foldable rotor blades 120. Rotor blades 118 and 120 may rotate in opposite directions to cancel the torque associated with the operation of each rotor system 114 and 116. The angle of the pivotable nacelles 115 and 117 relative to the wing, as well as the pitch of rotor blades 118 and 120, can be adjusted in order to selectively control direction, thrust, and lift of tiltrotor aircraft 100. Further, rotor systems 114 and 116 are illustrated in the context of tiltrotor aircraft 100; however, a singular rotor system with foldable rotor blades can be implemented on other non-tilting rotor and helicopter rotor systems. It should also be appreciated that teachings from tiltrotor aircraft 100 may apply to other aircraft such as airplanes and unmanned aircraft which would benefit from folding rotor blades.

Fuselage 102 represents the body of tiltrotor aircraft 100 and may be coupled to rotor systems 114 and 116 such that the rotor systems with rotor blades 118 and 120 may move tiltrotor aircraft 100 through the air. Landing gear 104 supports tiltrotor aircraft 100 when tiltrotor aircraft 100 is landing or when tiltrotor aircraft 100 is at rest on the ground. Vertical axis 122 is generally perpendicular to the longitudinal axis of the wing and is generally positioned at the intersection of the fuselage and the wing. FIG. 1A represents tiltrotor aircraft 100 in operational flying position in an airplane mode. FIG. 1B represents tiltrotor aircraft 100 in a stowed position where rotor blades 118 have been folded generally parallel with each other and rotor blades 120 have been folded generally parallel with each other in order to reduce the profile of the aircraft to whatever degree is required in response to storage space restrictions. In the stowed position, wing 108 is swivelled approximately 90° to generally align with fuselage 102.

Generally each rotor system includes a mast driven by a power source. A rotor system includes a yoke connected to the mast and rotor blades indirectly connected to the yoke with bearings. There may be inboard bearings connecting a cuff or grip of a rotor blade to the yoke proximate the mast and outboard bearings connecting the rotor blade to an outboard end of a yoke arm. Other combinations of inboard and outboard bearings with or without cuffs or grips are possible as well as the removal of one or the other bearings. The bearings accommodate forces acting on the rotor blades allowing each rotor blade to flex with respect to the yoke/mast and other rotor blades. The weight of the rotor blades and the lift of rotor blades may result in transverse forces on the yoke and other components. Examples of transverse forces may include forces resulting from flapping and coning of the rotor blades. Flapping generally refers to the up-and-down movement of a rotor blade positioned at a right angle to the plane of rotation. Coning generally refers to the upward flexing of a rotor blade due to lift forces acting on the rotor blade. The rotor blades may be subject to other forces, such as axial, lead/lag, and feathering forces. Axial forces generally refer to the centrifugal force on the rotor blades during rotation of the rotor blades. Lead and lag forces generally refer to forces resulting from the horizontal movement of the rotor blades about a vertical pin occurring if, for example, the rotor blades do not rotate at the same rate as the yoke. Feathering forces generally refer to forces resulting from twisting motions that cause a rotor blade to change pitch. The power source, mast, and yoke are components for transmitting torque. The power source may include a variety of components including an engine, a transmission, and differentials. In operation, the mast receives torque from the power source and rotates the yoke. Rotation of the yoke causes the rotor blades to rotate with the mast and yoke.

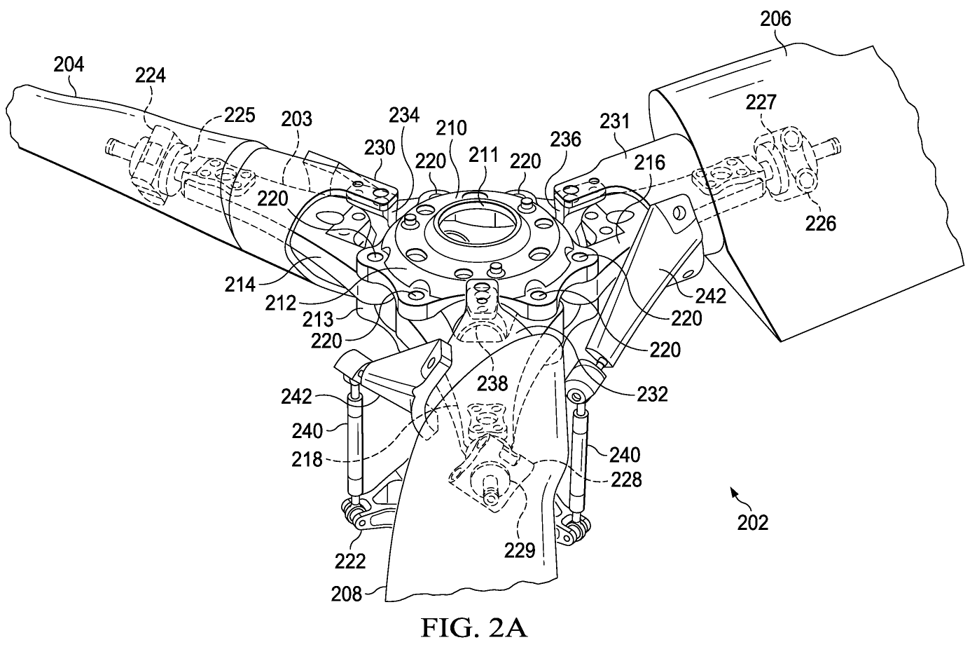

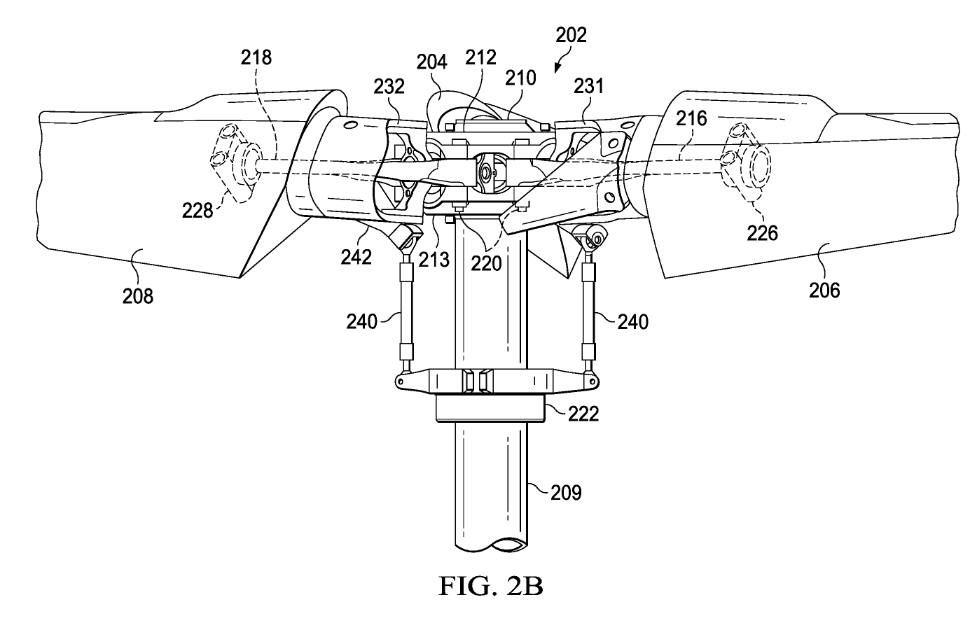

Referring to FIGS. 2A and 2B, blade assembly 202 is shown in an unfolded position. Each rotor system 114 and 116 comprises a separate blade assembly. In the interest of clarity, a single blade assembly is described herein with the understanding that tiltrotor aircraft 100 comprises a pair of similarly configured blade assemblies. Blade assembly 202 is shown in an unfolded position. In the unfolded position, each rotor blade 204, 206, and 208 is generally equally spaced from each other around mast 209. For example in the three rotor blade configuration shown, 120° separates each rotor blade. It should also be appreciated that teachings regarding blade assembly 202 can apply to blade assemblies having greater or fewer rotor blades. It should also be appreciated that teachings regarding blade assembly 202 can apply to blade assemblies not intended to fold.

Hub spring 210 is connected to mast 209 through a central opening 211 in the hub spring. Hub spring 210 is a bilateral disc comprised of upper hub 212 mounted to lower hub 213. A split yoke 203 includes a plurality of separate yoke arms where each yoke arm 214, 216, and 218 is individually attached to hub spring 210 between upper hub 212 and lower hub 213 with two bolts 220 at two separate attachment points. Bolts 220 pass through both upper hub 212 and lower hub 213 and the yoke arm. Each yoke arm is in double shear condition between upper hub 212 and lower hub 213. The double shear condition prevents any rotational moment about the connection of the yoke arm to the hub spring at each bolt 220 created by centrifugal forces acting on the rotor blade during blade assembly rotation. Opposite the connection to hub spring 210, yoke arms 214, 216, and 218 are connected to rotor blades 204, 206, and 208, respectively via outboard beams 224, 226, and 228, respectively. Outboard beams 224, 226, and 228 house outboard bearings 225, 227, and 229 that respond to centrifugal force acting on the rotor blades due to rotation. Rotor blades 204, 206, and 208 include integrally formed split cuffs 230, 231, and 232, respectively. Yoke arms 214, 216, and 218 are connected to split cuffs 230, 231, and 232, respectively via inboard beams 234, 236, and 238, respectively. Each integral split cuff provides a double shear condition that prevents any moment about the connection of the yoke arm to the cuff created by centrifugal forces acting on the rotor blade. Inboard beams 234, 236, and 238 house inboard bearings that allow the rotor blades to flex in response to shear forces on the rotor blades due to rotation. The outboard and inboard bearings are generally elastomeric bearings constructed from a rubber type material that absorb vibration and provide for limited movement of the rotor blades relative to the yoke arm and mast. The centrifugal force (“CF”) load path on each rotor blade is from the rotor blade, to the outboard bearing, and to the yoke arm. Although the location of centrifugal force bearings is disclosed as an outboard configuration within the outboard beams, it should also be appreciated that the location of centrifugal force bearings could alternatively be an inboard configuration within the inboard beams.

Swash plate 222 is connected to mast 209. Pitch links 240 extend from swash plate 222 and connect to pitch horns 242. A different pitch horn 242 is connected to each split cuff 230, 231, and 232. The swash plate, pitch links, and pitch horns are operatively connected to an actuator and used to pitch the rotor blades relative to the yoke arm about the central longitudinal axis of each rotor blade. During folding of the rotor blades, the pitch links may extend/telescope or temporarily disengage from their connection to the pitch horns. As an alternative, the pitch horns may extend/telescope, or partially disengage from their connection to the split cuff, to permit folding without positional movement of the pitch horns and pitch links.

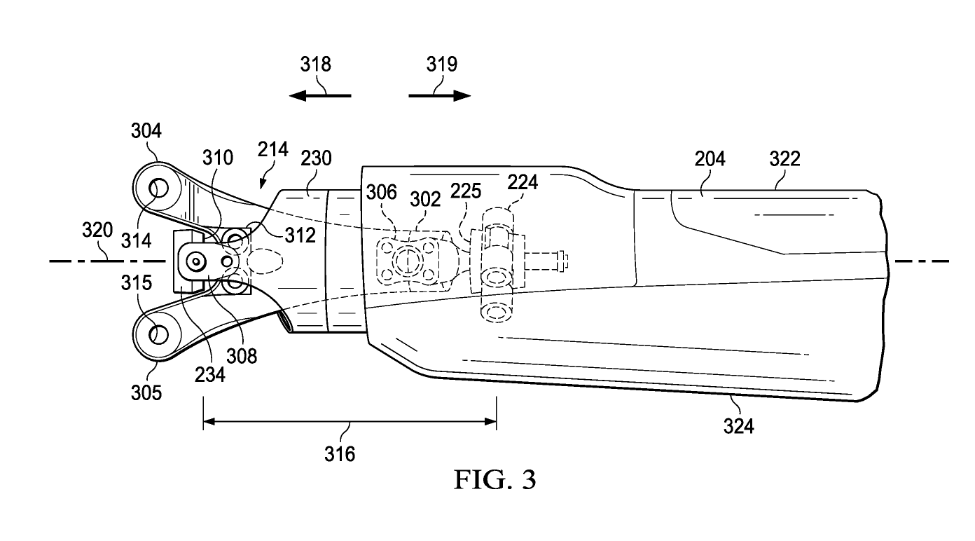

As illustrated in FIG. 3, yoke arm 214 is attached to rotor blade 204. Rotor blade 204 includes leading edge 322 and trailing edge 324. Yoke arm 214 is split into a generally “Y” shape including tip 302 opposite ends 304 and 305. In the interest of clarity, a single yoke arm and rotor blade is described herein with the understanding that a blade assembly comprises a plurality of similarly configured yoke arms and rotor blades. Clamp plate 306 is mounted to tip 302. Outboard bearing 225 extends between clamp plate 306 and outboard beam 224. Outboard beam 224 is connected to rotor blade 204. Inboard beam 234 is mounted to flanges 308 of split cuff 230. Clamp 312 is mounted to yoke arm 214 at the intersection of ends 304 and 305. Inboard bearing 310 extends between inboard beam 234 and clamp 312. Rotor blade 204 is free to rotate about its central longitudinal axis 320 with respect to yoke arm 214. The central longitudinal axis of a rotor blade may also be referred to as a blade pitch change axis. This rotation allows rotor blade 204 to pitch through an angle in the range of 45° to 90°. Ends 304 and 305 include mounting/pivot holes 314 and 315, respectively. Mounting/pivot holes 314 and 315 are sized to engage bolts 220. Distance 316 is the spacing between inboard beam 234 which houses inboard bearing 310 and outboard beam 224 which houses outboard bearing 225. Distance 316 is an optimal distance between inboard and outboard bearings for a rotor blade assembly of a particular aircraft. The distance is dependent on the particular aircraft's loads and dynamics. Inboard direction 318 points toward the drive mast of a blade assembly while outboard direction 319 points toward the unconnected end of a rotor blade.

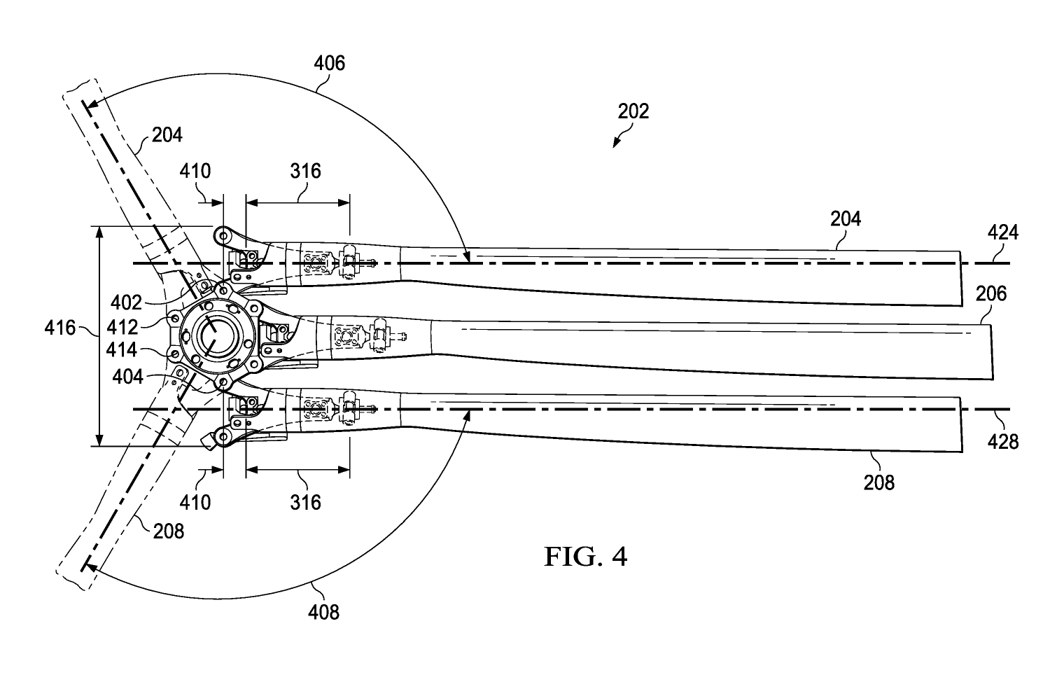

Referring to FIG. 4, blade assembly 202 is shown in a folded position. Unfolded rotor blade 204 and unfolded rotor blade 208 are depicted in shadow. Rotor blade 204 has central longitudinal axis 424. Rotor blade 208 has central longitudinal axis 428. Rotor blade 204 is pivoted about pivot point 402 through angle 406. Rotor blade 208 is pivoted about pivot point 404 through angle 408. Actuators operatively connected to the rotor blades facilitate movement of the rotor blades about the pivot points. Angles 406 and 408 may be in the range of 90° to 180°. Physical stops or proximity sensors signal the actuators to cease movement of the rotor blades.

Rotor blade 204 cannot pivot about pivot point 402 until the bolt at connection point 412 that connects one end of the yoke arm to the hub spring when in the unfolded position is pulled. Rotor blade 208 cannot pivot about pivot point 404 until the bolt at connection point 414 that connects one end of the yoke arm to the hub spring when in the unfolded position is pulled. The bolts at pivot points 402 and 404 provide pivot axes for the yoke arm and attached rotor blade to pivot with respect to the hub spring. Actuators connected to the bolts at connection points 412 and 414 pull or remove the bolts at connection points 412 and 414 so that the yoke arm is no longer connected to the hub spring at connection points 412 and 414. The bolts can be completely removed from engagement with the yoke arm and the hub spring or, alternatively, as part of a latch and lock system attached to the hub spring where the removable bolts remain fixed to the yoke arm. Once the bolts at connection points 412 and 414 are removed, the yoke arm and attached rotor blade are free to pivot about the single bolts at pivot points 402 and 404 still connecting the yoke arm to the hub spring.

Pivot points 402 and 404 are positioned inboard of the inboard beams of rotor blades 204 and 208, respectively. Pivot points 402 and 404 are distance 410 from the inboard beams of rotor blades 204 and 208, respectively. Distance 410 is measured parallel with central longitudinal axes 424 and 428. Pivot points 402 and 404 are not positioned on central longitudinal axes 424 and 428. In the folded position, pivot points 402 and 404 are located inboard of central longitudinal axes 424 and 428, respectively. The pivot point of each rotor blade positioned inboard of the inboard beams and inboard of the folded rotor blade central longitudinal axes allows folded profile 416 to be less than if the pivot point were outboard of the outboard beam.

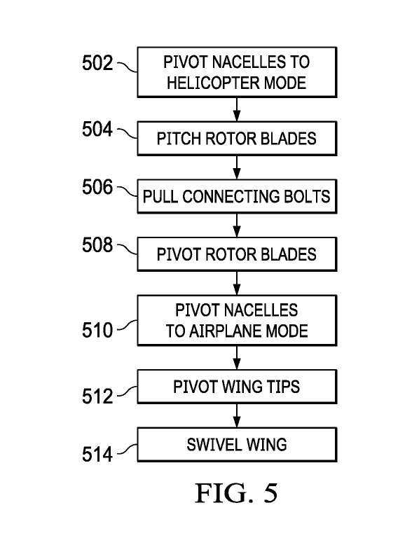

Referring to FIG. 5, the actions performed in converting tiltrotor aircraft 100 from a flight ready position to a stowed position are shown. At block 502, nacelles 115 and 117 which house rotor systems 114 and 116, respectively, are pivoted to helicopter mode. Each nacelle is rotated nose up to approximately 90° nacelle angle. A 90° nacelle angle is where the longitudinal axis of the nacelle is generally vertical relative to the ground. The blade assemblies of each rotor system are generally horizontal. At block 504, each rotor blade is pitched about its central longitudinal axis to high collective position. High collective is when the leading edge of each rotor blade is generally facing upward. This is referred to as indexing the rotor blades. Actuators operatively connected to pitch links 240 and pitch horns 242 facilitate the change in pitch of the rotor blades. At block 506, bolts connecting one end of the to-be-folded rotor blades to the hub spring are pulled. Actuators operatively connected to the bolts facilitate temporary removal of the bolts effectively disengaging one end of the yoke arm from connection to the hub spring. The position and number of identified to-be-folded rotor blades can vary depending on rotor assembly configuration. At block 508, the rotor blades and attached yoke arms are pivoted. Actuators operatively connected to the rotor blades facilitate pivoting the rotor blades about the still connected pivot points of the yoke arms. The rotor blades are pivoted toward the fuselage until the rotor blades are generally parallel with each other at which point physical stops or proximity sensors signal the actuators to cease movement of the rotor blades. At block 510, nacelles 115 and 117 are pivoted to airplane mode. Each nacelle is rotated to approximately 0° nacelle angle. 0° nacelle angle is where the longitudinal axis of the nacelle is generally horizontal relative to the ground. The blade assemblies of each rotor system remain generally horizontal. At block 512, wing tips 110 and 112 are pivoted toward the fuselage. At block 514, wing 108 is swivelled about vertical axis 122 to lie above and generally align with the fuselage. The entire sequence of converting tiltrotor aircraft 100 from an operational flight ready position to a stowed position can be completed in a range of 1 to 2 minutes in a wind of up to at least 60 knots. It can be interrupted or stopped at any point to facilitate maintenance. Manual operation is possible in the event of a system failure. It is to be understood that several of the previous actions may occur simultaneously or in different order. The order of actions disclosed is not meant to be limiting.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within [a percentage] of what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A split yoke for a folding rotor blade assembly, the split yoke comprising:
a bilateral hub spring including an upper hub spaced from a lower hub;
a yoke arm connected to the bilateral hub spring between the upper hub and the lower hub;
a first connection point of the yoke arm to the bilateral hub spring including a removable bolt; and
a second connection point of the yoke arm to the bilateral hub spring;
wherein the yoke arm pivots relative to the bilateral hub spring about the second connection point when the removable bolt is removed from the first connection point.

2. The split yoke of claim 1, wherein the yoke arm further comprises:
a first end connected to the upper hub and the lower hub at the first connection point; and
a second end connected to the upper hub and the lower hub at the second connection point.

3. The split yoke of claim 1, further comprising:
an inboard beam connected to the yoke arm between the first connection and the second connection;
an outboard beam connected to the yoke arm at a tip of the yoke arm opposite the first and second connections; and
wherein the pivot point is positioned inboard on the yoke arm relative to the inboard beam.

4. The split yoke of claim 1, wherein the first connection point and the second connection point each provide a double shear condition between the yoke arm and the bilateral hub spring.

5. The split yoke of claim 1, wherein the yoke arm further comprises:
a first end connected to the upper hub and the lower hub at the first connection point;
a second end connected to the upper hub and the lower hub at the second connection point;
an inboard beam connected to the yoke arm between the first connection and the second connection;
an outboard beam connected to the yoke arm at a tip of the yoke arm opposite the first and second connections; and
wherein the pivot point is positioned inboard on the yoke arm relative to the inboard beam.

6. The split yoke of claim 1, wherein the yoke arm further comprises:
a first end connected to the upper hub and the lower hub at the first connection point;
a second end connected to the upper hub and the lower hub at the second connection point; and
wherein the first connection point and the second connection point each provide a double shear condition between the yoke arm and the bilateral hub spring.

7. A system for folding a rotor blade assembly, comprising:
a hub spring operatively connected to a central mast;
a yoke arm connected to the hub spring at a releasable point and a pivot point; and
a plurality of bearings connecting the yoke arm to a rotor blade, the plurality of bearings positioned on the yoke arm outboard of the pivot point.

8. The system for folding a rotor blade assembly of claim 7, wherein the yoke arm is generally parallel with an adjacent yoke arm when the yoke arm is rotated about the pivot point to a folded position.

9. The system for folding a rotor blade assembly of claim 7, wherein the hub spring further comprises:
an upper disc connected to a first end of the yoke arm at the releasable point and connected to a second end of the yoke arm at the pivot point; and
a lower disc connected to the first end of the yoke arm at the releasable point and connected to the second end of the yoke arm at the pivot point.

10. The system for folding a rotor blade assembly of claim 7, wherein the yoke arm is connected to the hub spring at the releasable point with a removable bolt and the yoke arm is connected to the hub spring at the pivot point with a bolt providing a pivot axis.

11. The system for folding a rotor blade assembly of claim 10, wherein upon removal of the removable bolt, the yoke arm is no longer connected to the hub spring at the releasable point.

12. The system for folding a rotor blade assembly of claim 10, wherein upon removal of the removable bolt, the yoke arm becomes a pivotable yoke arm about the pivot point.

13. The system for folding a rotor blade assembly of claim 7, further comprising:
an inboard beam, housing an inboard bearing of the plurality of bearings, connected to the yoke arm between the releasable point and the pivot point and connected to the rotor blade.

14. The system for folding a rotor blade assembly of claim 7, further comprising:
an outboard beam, housing an outboard bearing of the plurality of bearings, connected to a tip of the yoke arm and connected to the rotor blade.

15. The system for folding a rotor blade assembly of claim 7, wherein the hub spring provides a double shear condition on the yoke arm at the releasable point and the pivot point.

16. A method for folding a rotor blade assembly comprising a yoke arm connected to a hub spring with a releasable connection and a pivotable connection, comprising:
pitching a rotor blade connected to the yoke arm;
releasing the releasable connection of the yoke arm; and
pivoting the yoke arm about the pivotable connection.

17. The method of claim 16, wherein:
the rotor blade assembly is connected to a nacelle pivotally mounted to a wing; and
pivoting the nacelle to a 90° nacelle angle.

18. The method of claim 17, further comprising:
subsequent to pivoting the yoke arm, pivoting the nacelle to a 0° nacelle angle.

19. The method of claim 16, wherein:
the rotor blade assembly is connected to a nacelle pivotally mounted to a wing; and
pivoting a wing tip of the wing.

20. The method of claim 16, wherein:
the rotor blade assembly is mounted to a wing, where the wing is mounted to a fuselage; and
subsequent to pivoting the yoke arm, swivelling the wing about its vertical axis to align with the fuselage.
